(19) United States
(12) Patent Application Publication
(10) Pub. No.: US 2007/0273326 A1
(43) Pub. Date: Nov. 29, 2007

(54) Charger with internal battery for charging portable batteries

(75) Inventors: Michael Krieger, Miami Beach, FL (US); Kevin Ellsworth, Hollywood, FL (US)

Correspondence Address: VENABLE LLP, P.O. BOX 34385, WASHINGTON, DC, 20043-9998, US

(73) Assignee: Black & Decker, Inc., Newark, DE (US)

(21) Appl. No.: 11/706,991

(22) Filed: Feb. 16, 2007

Related U.S. Application Data
(60) Provisional application No. 60/774,189, filed on Feb. 17, 2006.

(51) Int. Cl. H02J 7/00

(52) U.S. Cl. 320/110

(57) ABSTRACT

A charger for charging portable batteries includes a housing, an internal battery charging circuit disposed in the housing and adapted to be couple to external power, an internal rechargeable battery disposed in the housing and electrically coupled to the internal charging circuit, and a portable battery charging compartment supported by the housing and adapted for receiving at least one portable rechargeable battery. An electrical circuit is coupled between the portable battery compartment on the one hand and to the internal battery charging circuit and the internal rechargeable battery on the other hand so that the at least one portable rechargeable battery and the internal rechargeable battery are charged by the internal battery charging circuit when the external power is coupled to the internal battery charging circuit. The at least one portable battery is charged by the internal battery when the external power is unavailable.

This application claims the priority of Provisional Application No. 60/744,189, filed on Feb. 17, 2006, the subject matter of which is incorporated herein by reference.

### BACKGROUND OF THE INVENTION

Many battery-operated devices on the market today have been designed to accommodate portable batteries. Examples of portable batteries include cylindrical cells having “AA”, “C”, and “D” sizes. Various characteristics of portable batteries, such as dimensions, are specified by the American National Standard Specifications For Dry Cell Batteries as published by the American National Standards Institute, under ANSI C18 series.

Portable batteries that are rechargeable have become increasingly popular for use in flashlights, toys, calculators, radios, portable electronic devices and other types of battery-operated devices. Depending on battery chemistry, various chargers can be used to charge depleted portable batteries. Conventional chargers include circuitry that converts AC voltage from an external power source, for example, from an AC outlet, to DC charge current that is applied to recharge the portable batteries.

Such rechargeable portable batteries find valuable use for powering devices during power outages, provided that they are sufficiently charged. However, users often forget to charge the depleted batteries, which makes them useless during a power outage because they can not be recharged once the external power source is cutoff. Therefore, there exists a need for a charger that charges portable batteries even when the external power source is cut off, for example during a power failure.

### SUMMARY OF THE INVENTION

According to an exemplary embodiment of the invention, there is provided a charger for charging portable batteries, comprising: a housing; an internal battery charging circuit disposed in the housing and adapted to be couple to external power; an internal rechargeable battery disposed in the housing and electrically coupled to the internal charging circuit; a portable battery charging compartment supported by the housing and adapted for receiving at least one portable rechargeable battery; and an electrical circuit coupled between the portable battery compartment on the one hand and to the internal battery charging circuit and the internal rechargeable battery on the other hand, the at least one portable rechargeable battery and the internal rechargeable battery being charged by the internal battery charging circuit when the external power is coupled to the internal battery charging circuit, the at least one portable battery being charged by the internal battery when the external power is unavailable.

### BRIEF DESCRIPTION OF THE DRAWINGS

FIG. 1 is a top-right perspective view of the portable battery charger according to one embodiment of the invention, showing a door of the portable battery charging compartment in an open condition.

FIG. 2 is a view similar to FIG. 1 showing the door of the battery storage compartment in an open condition.

FIGS. 3A and 3B show, respectively, top and front transparent, elevation views of the charger shown in FIG. 1.

FIG. 4 shows a rear perspective view of the charger shown in FIG. 1.

FIG. 5 shows a perspective view of the charger of FIG. 1 mounted on a wall.

FIG. 6 is a schematic circuit diagram illustrating the electrical connections of a portable battery charger according to an embodiment of the invention.

### DETAILED DESCRIPTION OF THE INVENTION

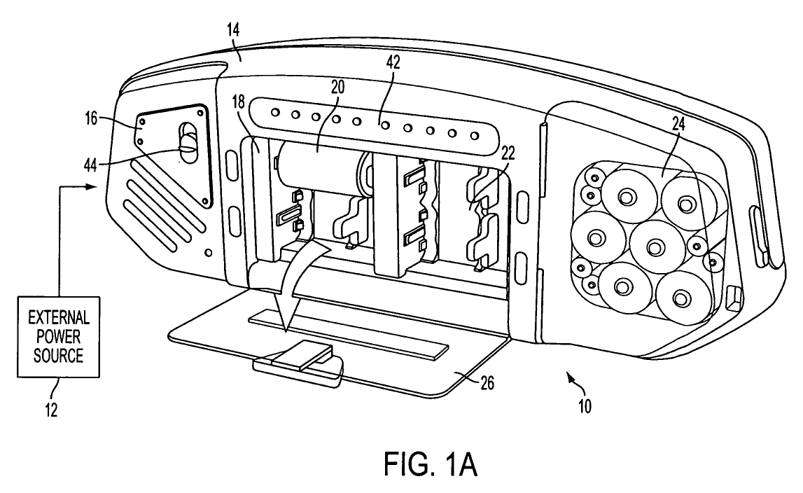

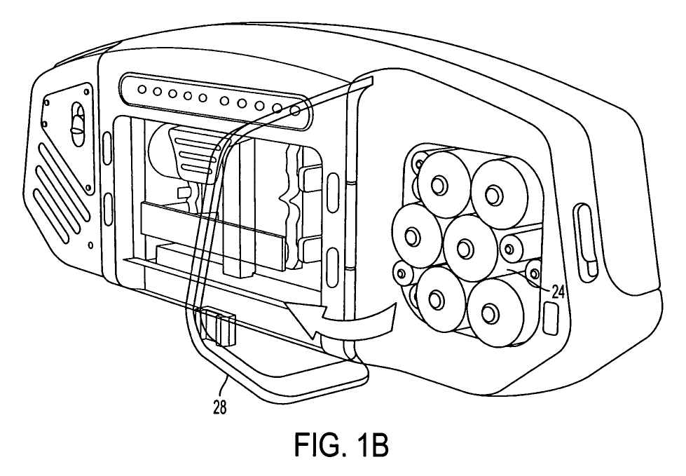

FIG. 1A shows a perspective view of a charger 10 according to one embodiment of the invention, which is powered by an external power source 12, such as an AC outlet. The charger 10 has a housing 14 made of an electrically insulating material, such as plastic. The housing 14 is divided into compartments defined by cavities for receiving and enclosing different types of batteries. An internal-battery compartment 16 enclosed by a removable cover houses an internal battery (not shown). One or more portable-battery charging compartments house one or more portable batteries 20. As defined herein, portable batteries comprise any rechargeable portable battery designated as such by any of the American National Standard Specifications as published by the American National Standards Institute, such as ANSI C18 series. Exemplary portable batteries are designated as AAA, AA, C and D and have wide household use.

In one embodiment, the portable-battery charging compartment is divided into charging sub-compartments 18 and 22 for accommodating various sizes of portable battery. In an exemplary embodiment, the portable-battery sub-compartments 18 and 22 are defined by cavities adapted to receive a variety of different sizes of cylindrical dry cell batteries, such as AAA, AA, C and D batteries. An optional storage compartment 24 is used for storage of all sizes of portable batteries. Pivoted cover door 26 extends over the portable battery charging sub-compartments 18 and 22 and door 28 covers the storage compartment 24, as shown in FIGS. 1A and 1B.

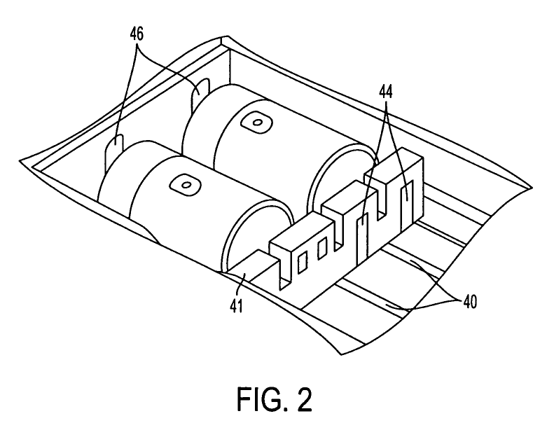

FIG. 2 show an exemplary sub-compartment 18 or 22 used accommodating various sizes of portable batteries. As shown, the compartment 18 or 20 has a rectangular shape provided with various contacts 44, 46, respectively, to connect to the contacts of different size and type batteries. The back side of the compartment is provided with slots 40 extending along at least part of its length. A slide member 41 moves along the slots 40. The contacts 44 and 46 are adapted to connect to battery electrodes of opposite polarity. For example, positive electrodes of batteries are connected to contacts 46 and negative electrodes of batteries are connected to contacts 44. The slide member 41 may move along the slots to fit different size batteries.

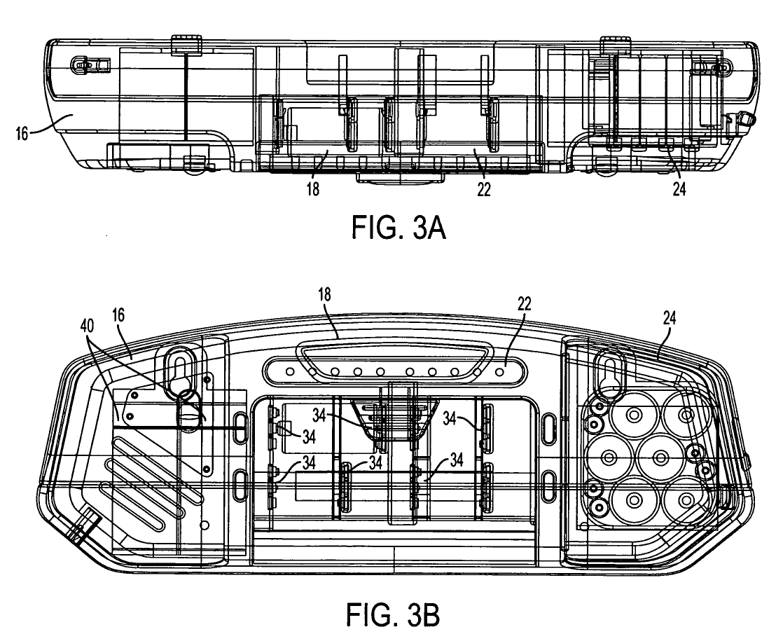

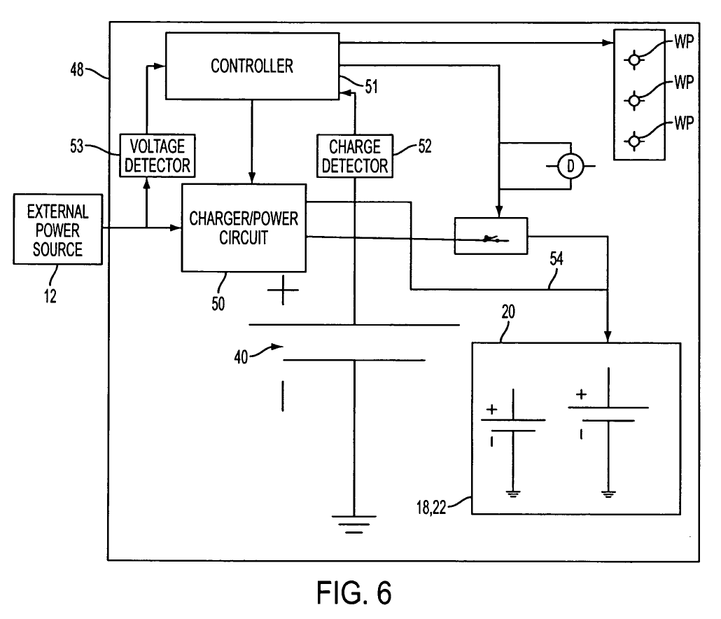

FIGS. 3A and 3B show, respectively, top and front transparent views of the charger 10 of the invention illustrating the positioning of the internal battery compartment 16, the portable battery charging sub-compartments 18 and 22 and the storage compartment 24 relative to each other. Each compartment (except the storage compartment) has properly positioned contacts 34 that electrically couple corresponding positive and negative terminals of the portable batteries 20 (shown in FIG. 1) and an internal battery 40 to each other. Such contacts 34 are also coupled to a charger circuitry (shown in FIG. 6) powered by the external power source 12 of FIG. 1 for charging the internal battery 40 and the portable batteries 20 when the external power source 12 is available. According to the invention, however, when the external power source 12 is cut off, charge energy for charging the one or more portable batteries 20 is supplied by the internal battery 40, which is charged during the availability of the external power source 12. Consequently, the absence of external power source 12, for example, during power outages or failures, does not prevent the use of the portable batteries 20 because they can be sufficiently charged by the energy stored in the internal battery 40 before the external power source 12 became unavailable. Preferably, the internal battery 40 is selected to provide sufficient charge energy for charging the portable batteries 20 when the external power source 12 is cut off. In one embodiment, the internal battery 40 may comprise one or more 12 Volt batteries with 3 amps per hour capacity that are normally charged by the external power source 12 via the internal charger circuit (shown in FIG. 6) during the availability of the external power source 12.

According to one feature of the invention, the charger 10 includes a lighting device 42 (shown in FIG. 1) powered by the internal battery that turns on when the external power source 12 is cut off to provide lighting to the surrounding area, for example, to facilitate locating the charger 10 and batteries under dark conditions. An on-off switch 44 shown in FIG. 1 is used for turning the lighting device on or off. The charger 10 may have additional indicator lights, which show the charge state of the internal and portable batteries while they are being charged.

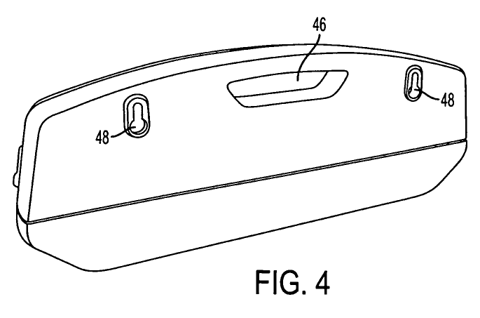

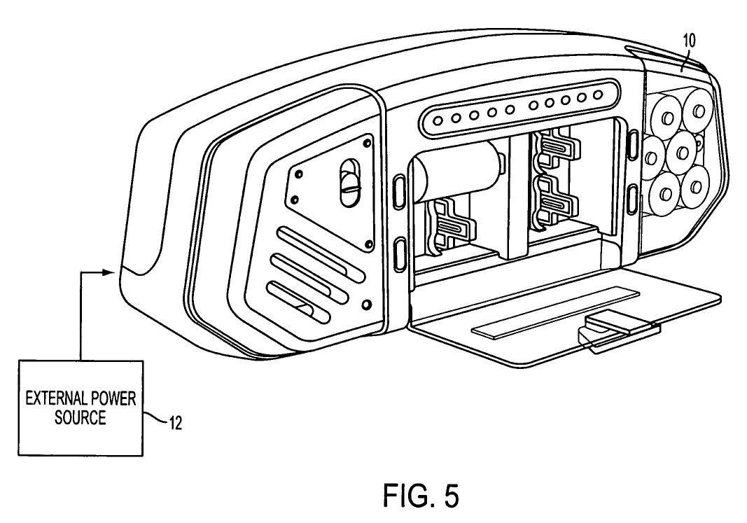

FIG. 4 shows the backside of the charger 10. As shown, the back side includes a handle 46 molded in the middle and mounting recesses 48 on either side. Thus, the charger 10 can be securely fastened to a wall, as shown in FIG. 5, adjacent an AC outlet or other external power source 12.

A schematic diagram of the electric circuit 48 for the charger 10 is shown in FIG. 6, which operates under the control of a controller 51. The controller 51 is a well known controller programmed to operate according to the present invention. The external power source 12, for example, an AC power source supplied from an outlet, is coupled a charger circuit 50, which provides charge current for charging the internal battery 40 while the external power source 12 is available. Under normal conditions when the external power source is not cut off, the charger circuit 50, which comprises a well known circuit that converts the AC power signal to a DC signal for charging purposes, charges the internal battery 40. A charge detector 52, e.g., a current detector, detects a specified charge condition for the internal battery 40, for example a fully charged condition, and provides a corresponding signal to the controller 51. Upon detection of the charge condition at the internal battery, the controller 51 signals the charge circuit 50 to apply charge current to the portable batteries 20. In this way the external power source is used to charge the internal battery 40 and the portable batteries 20 under normal operating conditions. An external power detector 53, e.g., a voltage detector, detects absence of the external power under abnormal conditions, for example due to a power outage or failure. If a power outage is detected, the controller operates a switch 54 to apply the power stored in the internal battery 40 to charge the portable batteries 20. The charger of the invention also includes a light 58 that turns on under the control of the controller when the external power source becomes on available. The control also controls the operation of charge indicator lights 57 in accordance with the charge state of the internal battery 40 and portable batteries 20.

The invention has been described in detail with respect to referred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

What is claimed is:

1. A charger for charging portable batteries, comprising:
a housing;
an internal battery charging circuit disposed in the housing and adapted to be couple to external power;
an internal rechargeable battery disposed in the housing and electrically coupled to the internal charging circuit;
a portable battery charging compartment supported by the housing and adapted for receiving at least one portable rechargeable battery; and
an electrical circuit coupled between the portable battery compartment on the one hand and to the internal battery charging circuit and the internal rechargeable battery on the other hand, the at least one portable rechargeable battery and the internal rechargeable battery being charged by the internal battery charging circuit when the external power is coupled to the internal battery charging circuit, the at least one portable battery being charged by the internal battery when the external power is unavailable.

2. The charger according to claim 1, wherein the housing further includes a storage compartment for storing portable batteries.

3. The charger according to claim 1, further comprising a lighting device coupled in the electrical circuit to be powered by the internal battery for automatically lighting up when the external power source is cut off.

4. The charger according to claim 1, wherein the housing of the charger includes a securing arrangement so that the housing can be mounted on a wall.

5. The charger according to claim 4, further comprising indicator lights coupled in the electrical circuit to show the charging state of the internal battery.

6. The charger according to claim 4, further comprising indicator lights coupled in the electrical circuit to show the charging state of the portable batteries.

7. The charger according to claim 1, wherein the portable battery charging compartment is divided into sub-compartments to accommodate different sized of portable batteries.
